(19) United States
(12) Patent Application Publication
(10) Pub. No.: US 2025/0010350 A1
(43) Pub. Date: Jan. 9, 2025

(54) Hot stamping die and hot stamping process using a hot stamping press

(71) Applicant: ArcelorMittal, Luxembourg (LU)

(72) Inventors: Alexandre BLAISE, Montataire (FR); Christophe TALLON, Angicourt (FR)

(21) Appl. No.: 18/709,293

(22) PCT Filed: Nov. 8, 2022
(86) PCT No.: PCT/IB2022/060739

§ 371 Date: May 10, 2024

(30) Foreign Application Priority Data
Nov. 18, 2021 (WO) PCT/IB2021/060686

(51) Int. Cl. B21D 22/02; B21D 37/01; B21D 37/16; B33Y 80/00

(52) U.S. Cl. CPC B21D 22/022; B21D 37/01; B21D 37/16; B33Y 80/00

(57) ABSTRACT

A hot stamping die (2,3) including a die body (11) having a work face (9) which is in contact with a blank during the hot stamping operation, and at least one porous die portion (4) having a corresponding porous work face portion (7), the porous die body portion being in contact with a reservoir (6, 40), the reservoir (6, 40) containing a cooling medium (8), and the porous die body portion including a plurality of ejection channels (5) extending from the reservoir (6, 40) to the porous work face portion, wherein the ejection channels (5) are configured to eject the cooling medium (8) from the reservoir (6, 40) towards the porous work face portion (7) when the pressure on the cooling medium is increased above a threshold ejection pressure, and wherein the die (2,3) does not include any discharge channels to evacuate excess ejected coolant from the dies after hot stamping.

The present invention relates to hot stamping in the metallurgic industry, and more specifically relates to a hot stamping die and a hot stamping press. The present invention also relates to a process for the hot stamping of metallic blanks like steel blanks using a hot stamping press.

The process of hot stamping press of hot metallic blanks—meaning metallic blanks at a temperature about or higher than 900 degrees Celsius—is known to allow hot press forming metallic blanks having high tensile and yield strengths into complex shapes.

### BACKGROUND

An important step during the hot stamping process is the quick cooling of the blank which has just been formed. Cooling methods are already known, for example from European patent application EP 3045236 and EP 1671715 that describe a hot-press stamping cooling method using a hot-press stamping device comprising a die body in which a plurality of channels is managed, said channels being connected to a refrigerant tank and leading to an ejection hole distributing refrigerant to the formed blank arranged in the hot stamping press.

### SUMMARY OF THE INVENTION

However, it remains difficult with this cooling process to ensure a uniform cooling of the metallic blanks. In addition, the amount of ejected refrigerant is high and discharge channels are needed to discharge refrigerant from the work faces of the dies. This costs time and refrigerant to cool down each pressed blank.

An aim of the present invention is to remedy the drawbacks of the prior art by providing a hot stamping die and hot stamping press that enhance efficiency and celerity of the cooling of the hot-formed metallic blanks.

The present invention also provides a hot stamping process using the hot stamping die and press of the invention.

The present invention provides a hot stamping die, comprising a die body having a work face which is in contact with a blank during the hot stamping operation, and at least one porous die portion having a corresponding porous work face portion, said porous die body portion being in contact with a reservoir, said reservoir containing a cooling medium, and said porous die body portion comprising a plurality of ejection channels extending from said reservoir to said porous work face portion,
wherein said ejection channels are configured to eject said cooling medium from the reservoir towards said porous work face portion when the pressure on the cooling medium is increased above a threshold ejection pressure, and wherein said die does not comprise any discharge channels to evacuate excess ejected coolant from the dies after hot stamping.

The hot stamping die according to the invention may also have the optional features listed below, considered individually or in combination:
each ejection channel of the porous die portion comprises a cylindrical portion.
the cylindrical portion of each ejection channel ends with a frustoconical part on the porous work face portion, the largest section of which is located on the porous work face portion.
the diameter of the cylindrical portion of the ejection channels is comprised between 0.1 and 0.5 millimeters.
the porous die portion is made of steel or stainless steel.
the porous die portion is located in a cavity managed in the die body which opens onto the hot stamping work face.
the die is designed to be used in a stamping press, said stamping press being closed following a stamping direction during the hot stamping operation and wherein at each point of its surface, the angle between the perpendicular direction to the die work face and the stamping direction is an angle α comprised between 0° and 90°, and wherein the die comprises a porous die portion at least in all the areas in which a is comprised between 45° and 90°.
each of the upper and lower die comprises at least one porous die portion located in a cavity which opens onto the corresponding hot stamping die work face.
the porous die portion occupies the entire die body.

The present invention also provides a die as previously described, wherein the porous section of the die is made by additive manufacturing.

The present invention also further provides a hot stamping process using a hot stamping press fitted with an upper die and a lower die, at least one of said dies comprising a work face, which is in contact with the blank during the hot stamping operation, a die body, which is in contact with a reservoir, said reservoir containing a cooling medium, wherein said work face comprises a porous work face portion and wherein said lower die comprises a porous die body portion comprising a plurality of ejection channels extending from said reservoir to said porous work face, wherein said ejection channels can eject said cooling medium from the reservoir towards said porous work face during the hot stamping process, and wherein the reservoir is equipped with a pressurizing device which can be activated to increase the pressure of the cooling medium within said reservoir above threshold ejection pressure and deactivated to release the additional pressure on the cooling medium, said hot stamping process comprising the steps of:
(i) activating the pressurizing device in order to gorge said ejection channels up until the cooling medium reaches the porous work face portion,
(ii) heating a steel blank,
(iii) transferring said steel blank to the hot stamping press,
(iv) deactivating the pressurizing device,
(v) positioning the blank into the hot stamping press, and
(vi) hot stamping said steel blank by clamping the upper and lower dies, wherein step i can take place simultaneously to step ii and step iii and wherein step iv takes place after step i and before step vi.

Preferably, the cooling medium is an aqueous solution.

Most preferably, the cooling medium is water.

Other characteristics and advantages of the invention will be described in greater detail in the following description.

### BRIEF DESCRIPTION OF THE DRAWINGS

The invention will be better understood by reading the following description, which is provided purely for purposes of explanation and is in no way intended to be restrictive, with reference to:

FIG. 1, which represents a cross section view of the hot stamping press of the invention comprising a hot stamping lower die and a hot stamping upper die;

FIG. 2, which represents a cross section view of the hot stamping press of FIG. 1 with a hot blank between the dies;

FIG. 3, which represents a cross section view of the hot stamping press of FIG. 1 with the formed blank between the dies;

FIG. 4, which represents a cross section view of part of the die body included the porous die portion comprising ejection channels connected to a coolant reservoir;

FIG. 5, which represents a perspective view of a porous die portion of the hot stamping die of the invention;

FIG. 5a, which represents a detailed perspective view of the work face of the porous die portion of FIG. 5;

FIG. 5b, which represents a cross section A-A of FIG. 5a of a first embodiment of the ejection channels of the porous die portion of FIG. 5;

FIG. 5c, which represents a cross section A-A of FIG. 5a of a second embodiment of the ejection channels of the porous die portion of FIG. 5;

FIG. 6, which represents a cross section view of the part of the die body of FIG. 4 while the ejections channels of the porous die portion are ejecting coolant to the work face of the porous die portion;

FIG. 7, which represents the same view as FIG. 4 with a blank getting down to the work face;

FIG. 8, which represents the blank lying on the work face of the porous portion of the sweating die of FIG. 6;

FIG. 9, which represents perspective view of an omega-shaped hot stamping die of the invention;

FIG. 10, which represents a perspective view of a hot stamping lower die of the invention designed for car industry;

### DETAILED DESCRIPTION

It should be noted that the terms “lower”, “upper”, “above”, “below”, “lowest”, “highest”, “top”, “bottom”, “left”, “right” as used in this application refer to the positions and orientations of the different parts of the reinforced carrier device, of the battery pack and of the vehicle when they are positioned vertically on the ground. The terms “perpendicular” define an angle of 90°+/−15° and the terms “parallel” define an angle of 0°+/−15°. Hot stamping is a forming technology which involves heating a blank up to a temperature at which the microstructure of the steel has at least partially transformed to austenite, typically around 900° C., forming the blank at high temperature by stamping it and quenching the formed part to obtain a microstructure having a very high strength. Hot stamping allows to obtain very high strength parts with complex shapes and no springback. In order to yield the described benefits of hot stamping, the material used is known as press-hardening material, which has a chemical composition allowing it to form the desired hardened microstructure when submitted to the above described hot stamping process.

Additive manufacturing is a manufacturing process whereby computer-aided-design (CAD) data is used to direct a hardware to deposit material, often layer upon layer, in precise geometric shapes reproducing said CAD data.

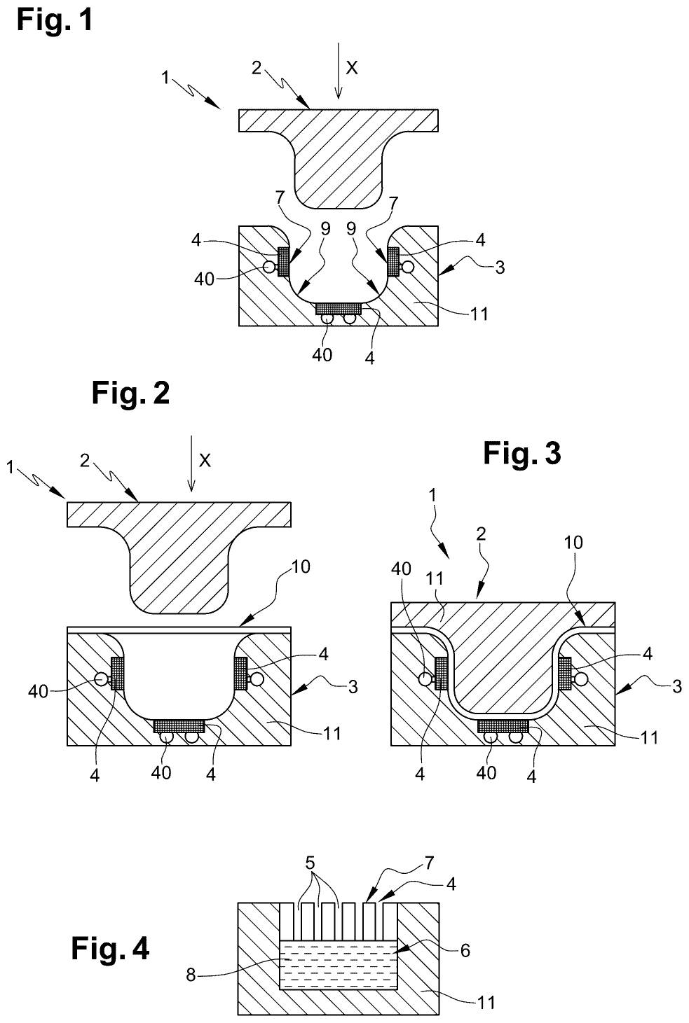

According to FIGS. 1 to 5, the invention discloses a hot stamping press 1 comprising at least a lower die 3 and an upper die 2. As depicted in FIGS. 1 to 3, the lower 3 and upper 2 dies are complementary shaped in order to allow the deformation of a hot metallic blank 10 into a metal part with the desired volumetric shape. Advantageously, the lower 3 and upper 2 dies are made of steel or stainless steel.

In the following description and in the attached figures, the invention will be detailed, for simplicity sake, only in the case of a lower die 3. It should be understood however that it can also be applied to an upper die 2 and can be applied to both the upper and lower dies 2,3 of a same hot stamping press 1.

The lower die 3 comprises a die body 11 having a work face 9 provided to be in contact with the blank 10 during hot stamping operation. The lower die 3 also comprises a plurality of porous die portions 4 managed inside the lower die body 11. Each porous die portion 4 has a porous work face portion 7 and comprises a plurality of ejection channels 5 that lead to the porous work face portion 7 of the considered porous die portion 4. The ejection channels 5 of each porous die portion 4 are in fluid contact with a reservoir 6 of cooling medium 8 further called “coolant”. Said reservoir 6 is depicted in FIG. 4 as being managed inside a cavity of the lower die body 11. This is however only one particular embodiment. Generally speaking, the reservoir 6 can also be located away from the die body 11 and the coolant 8 can be distributed to the porous die portion 4 through a pipe. It is also possible to have a configuration whereby there are a plurality of reservoirs 6, as long as each porous die portion 4, in the case where there are several porous die portions 4, is adequately supplied with coolant 8. In other words, each porous die portion 4 is connected in a fluidic manner with a reservoir 6. In a particular embodiment, as depicted on FIGS. 1 to 3, the coolant 8 is supplied to the porous die portion 4 using the cooling circuit 40 of the dies themselves. Indeed, in order to cool down the dies 2,3 during the hot stamping process, they are equipped with a cooling circuit 40, which is not normally in contact with the surface of the dies, but only circulates inside the die body 11. The coolant 8 is constantly circulated within said cooling circuit 40 during the hot stamping process in order to limit the temperature increase of the dies 2,3, which could eventually diminish the quenching efficiency of said dies 2,3.

The coolant 8 may be an aqueous solution like salted or unsalted water, or any other liquid refrigerant adapted to cool down hot metal blanks 10 being stamped.

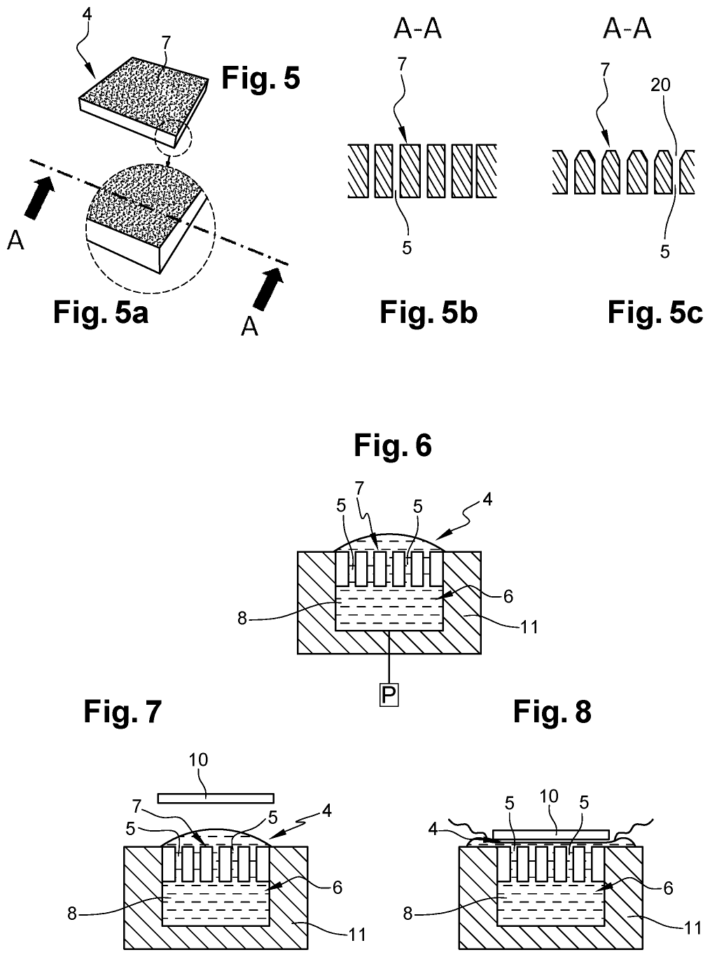

As depicted in FIGS. 5 and 5a, the ejection channels 5 are regularly disposed into the considered porous die portion 4 following a matrix-like pattern. In a first variant depicted in FIG. 5b, the ejection channels 5 are cylindrical. The diameter of each channel 5 is comprised between 0.1 and 0.5 millimeters, preferentially between 0.2 and 0.4 millimeters. In a second variant depicted in FIG. 5c, each ejection channel 5 comprises a cylindrical portion that ends with a frustoconical part 20, the largest section of which is located on the porous work face portion 7 of the considered porous die portion 4. Following this second variant, the liquid coolant 8 spreads better on the porous work face portion 7 of the considered porous die portion 4, and more broadly on the work face 9 of the lower die 3. The diameter of the cylindrical part of each channel 5 is comprised between 0.1 and 0.5 millimeters, preferentially between 0.2 and 0.4 millimeters.

In both variants, the ejection channels 5 are configured to eject the coolant 8 from the reservoir 6 toward the porous work face portion 7 when the pressure of the coolant 8 is increased above a threshold ejection pressure. To allow that, a pressurizing device (net illustrated solely schematically as P in FIG. 6) is connected to the reservoir 6, said pressurizing device being controlled by control means in order to increase the pressure of the coolant 8 in above a threshold ejection pressure. Said threshold ejection pressure depends on the coolant 8 which is employed and on the specific configuration of the ejection channels 5 that are being used. For a viscous coolant 8, a higher threshold ejection pressure will be necessary. For narrow ejection channels 5, a higher threshold ejection pressure will be necessary.

In addition, since the amount of ejected coolant 8 is low enough to produce a complete vaporization of the coolant 8 on the work face 9 of the lower die 3 during cooling of the pressed blank 10, the lower and upper dies 2, 3 do not need to comprise any discharge channel to evacuate excess ejected coolant 8 from the dies after hot stamping.

Thanks to the diameter of the ejection channels 5 and thanks to their capacity to eject an amount of coolant 8 that is totally vaporized, the hot stamping die 2, 3 acts as a “sweating” die with reference to the natural perspiration phenomenon.

As depicted in FIG. 1, the lower die 3 comprises several porous die portions 4 that may be located into the bottom wall of the die body 11 and, preferentially, into the side walls of said die body 11 since the accuracy of the contact between the blank 10 and the work face 9 is the lowest against said side walls, which can lead to lower quenching speeds in said side walls. More precisely, considering the hot stamping press 1 being closed following a stamping direction X and considering the angle α between a perpendicular direction to the die work face 9 and the stamping direction X, said angle α being comprised between 0° and 90°, the porous die portions are preferentially disposed in areas of the lower die 3 in which a is comprised between 45° and 90°. The advantage of such a configuration is that the blank 10 pressed between the dies 2, 3 undergoes lower contact pressure in the areas of the lower die 3 in which a is comprised between 45° and 90°. Furthermore, the lower the contact pressure is, the worst the heat transfer between the blank 10 and the dies 2, 3 is. It is thus of particular interest to dispose the porous die portions 4 in the areas of the lower die 3 where the heat transfer with the blank 10 is the worst, meaning in the areas of the lower die 3 where a is comprised between 45° and 90°, in order to ensure quicker and more uniform cooling of the pressed blank 10.

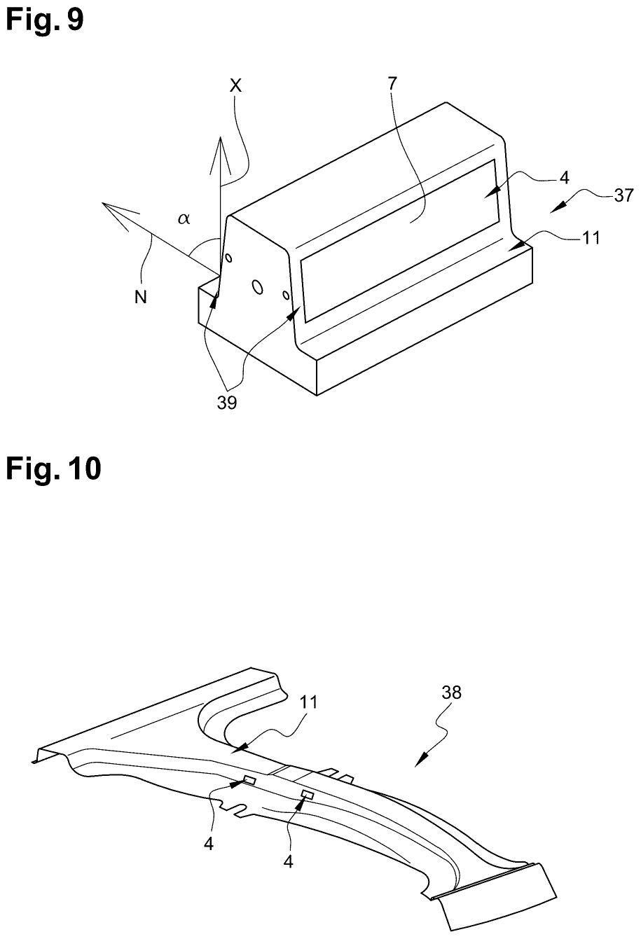

Following this configuration, FIG. 9 shows an omega-shaped lower die 37 having a porous die portion 4 disposed on the opposite lateral faces 39 of said die 37 where the angle α between the stamping direction X and a perpendicular direction N to the porous work face portion 7 of said porous die portion 4 is comprised between 45° and 90°.

FIG. 10 shows an industrial lower die 38 managed to press a steel blank in order to form an automotive member (a B-pillar in the case of FIG. 10). As depicted in this FIG. 10, the porous die portions 4 are managed on the lateral face of the industrial die 38 in an area where a is comprised between 45° and 90°.

In another embodiment, the entire lower die body 11 is made of the porous die portion 4.

On the other hand, in a particular embodiment, it is also possible to have the entire die (lower and upper die) made of a porous portion 4—this can have industrial advantages in terms of tool design simplicity for example.

In a particular embodiment, the porous die portion 4 is manufactured using additive manufacturing. Advantageously, additive manufacturing allows to produce complex metallic shapes with very precise dimensions, such as the porous die portion 4, which has a high density of narrow ejection channels. Other more traditional manufacturing means can also be employed to produce a porous die portion 4, such as metal casting of the final shape directly or casting a bloc of metal into which the ejection channels 5 are subsequently drilled (also known as “subtractive manufacturing” processes).

In a particular embodiment, the porous die portion 4 is produced by additive manufacturing with the following features:
additive manufacturing process: powder bed fusion
printing under inert gas, using argon as the inert gas
layer thickness of 50 microns
lasers used: four 500W Yb Lasers
powder used: 316L stainless steel powder having the following typical chemical composition and granulometry:

TABLE 1
Example of chemical composition of the powder
used to produce the porous die portion 4

| Element | Weight % |
|---|---|
| Fe | Balance |
| C | 0.032 |
| S | 0.005 |
| N | 0.073 |
| O | 0.023 |
| Cr | 18.10 |
| Cu | 0.024 |
| Ni | 13.10 |
| Mo | 2.41 |
| Mn | 13.10 |
| P | 0.009 |
| Si | 0.58 |
| Nb | 0.02 |
| Ta | 0.02 |

TABLE 2
Example of granulometry according to ASTM B822 standard
of the powder used to produce the porous die portion 4

| Particle size | Weight % in the powder |
|---|---|
| D10 | 19.15 |
| D20 | 22.2 |
| D50 | 28.68 |
| D75 | 34.5 |
| D90 | 39.6 |

According to FIGS. 2 to 8, a hot stamping process with the hot stamping press 1 of the invention is now described.

In a first step, the control means activates the pressurizing device P above the threshold ejection pressure in order to gorge the ejection channels 5 up until the coolant 8 reaches the porous work face portion 7 of the considered porous die portion 4 (FIG. 6).

In a second step, a blank 10, preferentially a steel blank 10, is heated to a desired temperature, typically around 900 or 1000 degrees Celsius.

In a third step, said hot steel blank 10 is transferred to the hot stamping press 1, as depicted in FIG. 7.

In a fourth step, the control means deactivates the pressurizing device, meaning that the pressure in the reservoir 6 slowly decreases to below the threshold ejection pressure. More precisely, once the pressurizing device is deactivated, the pressure in each reservoir 6 naturally decreases because of coolant 8 vaporization due to the hot steel blank transfer during the third step. The diameter of the ejection channels 5 is small enough to avoid the coolant 8 going back to the reservoir 6. The deactivation of the pressurizing device may be implemented just after the first step of the process and always before hot stamping said steel blank 10 by clamping the upper 2 and lower 3 dies.

In a fifth step and as depicted in FIG. 8 and FIG. 2, the blank 10 is positioned on the work face 9 of the corresponding hot stamping lower die 3.

In a final sixth step, as depicted in FIG. 3, the hot stamping press 1 is closed and the upper and lower dies 2, 3 are clamped, in order to hot stamp the steel blank 10.

To improve celerity of the process, the first, second and third steps may be implemented simultaneously. In addition, the deactivation of the pressurizing device that occurs always before the sixth step of the process also allows complete vaporization of the coolant 8 between the work face 9 and the blank 10. There is no return of coolant 8 lying on the porous work face portions 7 to the reservoir 6 through the ejection channels 5.

What is claimed is:

1-13. (canceled)

14. A hot stamping die comprising:
a die body having a work face in contact with a blank during the hot stamping operation; and
at least one porous die portion having a corresponding porous work face portion, the porous die body portion being in contact with a reservoir containing a cooling medium and is equipped with a pressurizer activatable to increase a pressure of the cooling medium within the reservoir above a threshold ejection pressure and deactivatable to release additional pressure on the cooling medium, the porous die body portion including a plurality of ejection channels extending from the reservoir to the porous work face portion;
the ejection channels configured to eject the cooling medium from the reservoir towards the porous work face portion when the pressure on the cooling medium is increased above the threshold ejection pressure, the die not having any discharge channels to evacuate excess ejected coolant from the die after hot stamping.

15. The hot stamping die as recited in claim 14 wherein each of the plurality of ejection channels includes a cylindrical portion.

16. The hot stamping die as recited in claim 15 wherein the cylindrical portion of each ejection channel ends with a frustoconical part on the porous work face portion, the largest section of the frostoconical part being located on the porous work face portion.

17. The hot stamping die as recited in claim 15 wherein a diameter of the cylindrical portion of the ejection channels is between 0.1 and 0.5 millimeters.

18. The hot stamping die as recited in claim 14 wherein the porous die portion is made of steel

19. The hot stamping die as recited in claim 18 wherein the steel is stainless steel.

20. The hot stamping die as recited in claim 14 wherein the porous die portion is located in a cavity managed in the die body, the cavity opening onto the hot stamping work face.

21. The hot stamping die as recited in claim 14 wherein the die is designed to be used in a stamping press, the stamping press being closed following a stamping direction during the hot stamping operation and wherein at each point of a surface, an angle between a perpendicular direction to the die work face and the stamping direction is an angle α comprised between 0° and 90°, and wherein the die includes the at least one porous die portion at least in all the areas where a is between 45° and 90°.

22. The hot stamping die as recited in claim 14 wherein each of the upper and lower die includes at least one porous die portion located in a cavity opening onto the corresponding hot stamping die work face portion.

23. The hot stamping die as recited in claim 14 wherein the porous die portion occupies the entire die body.

24. The hot stamping die as recited in claim 14 wherein the porous die portion is manufactured by additive manufacturing.

25. A hot stamping process using a hot stamping press fitted with an upper die and a lower die, at least one of the upper and lower dies including a work face in contact with the blank during the hot stamping operation, a die body in contact with a reservoir, the reservoir containing a cooling medium, the work face including a porous work face portion, the lower die including a porous die body portion including a plurality of ejection channels extending from the reservoir to the porous work face, the ejection channels capable of ejecting the cooling medium from the reservoir towards the porous work face during the hot stamping process, and the reservoir being equipped with a pressurizer activatable to increase a pressure of the cooling medium within the reservoir above a threshold ejection pressure and deactivatable to release additional pressure on the cooling medium, the die not having any discharge channels to evacuate excess ejected coolant from the dies after hot stamping, the hot stamping process comprising the steps of:
(i) activating the pressurizer in order to gorge the ejection channels up until the cooling medium reaches the porous work face portion,
(ii) heating a steel blank,
(iii) transferring the steel blank to the hot stamping press,
(iv) deactivating the pressurizer,
(v) positioning the steel blank into the hot stamping press, and
(vi) hot stamping the steel blank by clamping the upper and lower dies, wherein step i can take place simultaneously to step ii and step iii and wherein step iv takes place after step i and before step vi.

26. The process as recited in claim 25 wherein the cooling medium is an aqueous solution.

27. The process as recited in claim 25 wherein the cooling medium is water.
